(19) United States
(12) Patent Application Publication
(10) Pub. No.: US 2023/0006520 A1
(43) Pub. Date: Jan. 5, 2023

(54) MOLDING-ON TOOL AND METHOD FOR PRODUCING A ROTOR

(71) Applicant: Schaeffler Technologies AG & Co. KG, Herzogenaurach (DE)

(72) Inventors: Volker Lang, Lauf (DE); Markus Sum, Haslach (DE); Moritz Wagenblatt, Erfweiler (DE)

(73) Assignee: Schaeffler Technologies AG & Co. KG, Herzogenaurach (DE)

(21) Appl. No.: 17/782,751

(22) PCT Filed: Oct. 21, 2020
(86) PCT No.: PCT/DE2020/100909

§ 371 Date: Jun. 6, 2022

(30) Foreign Application Priority Data
Dec. 11, 2019 (DE) 10 2019 133 992.8
Jun. 2, 2020 (DE) 10 2020 103 047.9

(51) Int. Cl. H02K 15/03; H02K 15/12

(52) U.S. Cl. CPC H02K 15/03; H02K 15/12

(57) ABSTRACT

A molding-on tool for producing a rotor, the rotor having a plurality of stacks, which are stacked one over the other in the axial direction and each have a magnet carrier and a plurality of magnets fastened thereto. Plastic is molded onto the magnets in order to fix the position on the magnet carrier, the molding-on tool having at least two molding-on plates, which are provided for feeding plastic in order to mold plastic onto the magnets.

### CROSS-REFERENCE TO RELATED APPLICATIONS

This application is the U.S. National Phase of PCT Appln. No. PCT/DE2020/100909 filed Oct. 21, 2020, which claims priority to DE 102019133992.8 filed Dec. 11, 2019 and DE 102020103047.9 filed Feb. 6, 2020, the entire disclosures of which are incorporated by reference herein.

### TECHNICAL FIELD

The disclosure relates to a molding-on tool for producing a rotor for an electric motor, the rotor having a plurality of stacks, which are stacked one over the other in the axial direction and each have a magnet carrier/a stack of sheets and a plurality of magnets fastened thereto, plastic being molded onto the magnets in order to fix the position on the magnet carrier. Accordingly, the rotor is made up of a plurality of stacks, which are stacked one over the other in the axial direction, each having a magnet carrier and a plurality of magnets molded onto the magnet carrier. Furthermore, the disclosure relates to a method for producing such a rotor.

### BACKGROUND

Molding-on tools and production methods for a rotor of an electric motor are already known from the prior art. For example, each stack can be molded individually. This means that a single magnet carrier is placed in the molding-on tool or press and the magnets of a magnet carrier of a stack are molded on. However, this has the disadvantage that a large amount of sprue material is lost for each stack. Stacks can also be placed in a multi-cavity tool and molded separately in the multi-cavity tool. This has the disadvantage that the separate molding results in a large amount of sprue material being lost, the space requirement of the multi-cavity tool and press is high, and a larger press with higher tonnage may be required.

It is also already known to insert the stacks in their final orientation of the later rotor with the magnets built up and in the package into the molding-on tool or press and to mold them in one go. This has the disadvantage that the melt of plastic flows through the stack in a chaotic manner, so that the position of the magnets cannot be precisely fixed.

### SUMMARY

It is therefore the object of the disclosure to avoid or at least to mitigate the disadvantages of the prior art. In particular, a molding-on tool and a method for producing a rotor are to be provided, by means of which the rotor can be produced inexpensively, in particular with a small amount of sprue material, and the magnets of all stacks can be precisely impinged on; for example, so that they are in the same position.

This object is achieved with a generic device according to the disclosure in that the molding-on tool has at least two molding-on plates, preferably more than two molding-on plates, which are prepared for feeding plastic, in particular epoxy resin, in order to mold plastic onto the magnets. Preferably, according to the disclosure, a molding-on plate is provided for each of the majority of the individual stacks, which molding-on plate is prepared for feeding plastic in order to mold plastic onto the magnets.

This has the advantage that, in particular in the case of a rotor that is made up of a plurality of (individual) stacks, it can be ensured that all stacks or the magnets in the individual stacks can be specifically molded such that all magnets in the individual stacks are in the same position.

Advantageous embodiments are claimed and are explained below.

According to a preferred embodiment, a molding-on plate can be formed as a sprue plate arranged as an outermost molding-on plate on an axial side of all the stacks, and at least one molding-on plate can be formed as an intermediate plate arranged as an inner molding-on plate inside the entirety of the stacks. In other words, the sprue plate is arranged as a molding-on plate on the side facing away from all the stacks as the outermost molding-on plate or is arranged as an intermediate plate inside the entirety of the stacks.

In an advantageous further development of the disclosure, each stack can have its own molding-on plate. This has the advantage that each stack can be molded individually through its own molding-on plate, so that a flow of the plastic can be controlled in a targeted manner. In this way, each magnet can be specifically pressed into the desired position by the injection pressure.

Preferably, the intermediate plate is arranged between two axially adjacent stacks. it is particularly preferred if an intermediate plate each is arranged between two axially adjacent stacks, i.e., between each pair of stacks. This means that each stack can be molded individually; for example, a first/top stack via the sprue plate and each further stack via the associated intermediate plate, i.e., arranged directly above it in the direction of gravity. The fact that the stacks are molded individually, but only one sprue plate has to be provided, significantly reduces the loss due to sprue material.

In addition, it is advantageous if at least one of the molding-on plates, in particular the sprue plate, has a plastic guiding device for guiding the plastic. In other words, the molding-on plate is provided with plastic guiding features and/or plastic dispensing devices, such as in the manner of conduits, channels, grooves, and/or nozzles. By providing a plastic guiding device; for example, in the form of sprue channels, conduit or grooves, the plastic can be introduced via a plastic introducing device, in particular into the sprue plate, and from there be further distributed, for example to the plastic dispensing device. In particular, the sprue plate can have a plurality of channels for distributing the plastic to the plastic dispensing device. It has proved particularly advantageous if the channels are arranged in a star shape, in particular in the shape of a snowflake. In other words, the channels branch radially outward and in the circumferential direction of the molding-on plate. This means that the amount of sprue material required can be kept to a minimum.

Furthermore, it is advantageous that the molding-on plates, preferably each molding-on plate, each have a plastic dispensing device for feeding the plastic to the stack associated with the molding-on plate. This ensures a material feed to all molding-on points of the magnets. By providing a plastic dispensing device; for example, in the form of openings or nozzles, a material feed to the individual magnets can be ensured. For example, molding nozzles of the intermediate plates and/or the sprue plate can be designed as through holes.

It is particularly advantageous if the plastic dispensing device is matched to the position of the magnets of the stacks to be molded in such a way that the magnets can be molded from behind. This allows the magnets to be pressed into a desired position by the injection pressure. In this manner, a frequent requirement for the magnets to abut on the outside can be fulfilled. This means that the molding nozzles of the plastic dispensing device are matched to the position of the magnets of the stacks to be molded in such a way that the magnets can be molded, in particular, from behind or radially inwards or so that they are pressed in the direction of the outer contour.

The object of the disclosure is achieved by a method for producing a rotor, the rotor having a plurality of stacks, which are stacked one over the other in the axial direction and each have a magnet carrier and a plurality of magnets molded onto the magnet carrier, wherein in one step a magnet carrier is equipped with magnets and a plurality of magnet carriers equipped with magnets are stacked one over the other in the axial direction, wherein in another step at least one molding-on plate is arranged between two magnet carriers, wherein in a further step plastic is fed to the molding-on plate in order to mold the magnets associated with the magnet carrier onto the magnet carrier at a magnet carrier associated with the molding-on plate.

According to a preferred embodiment of the method, the plurality of magnet carriers equipped with magnets can be stacked one over the other in the same orientation in the circumferential direction. As a result, the magnet carriers can be placed on top of each other in a time-saving and simple manner for example in an automated or partially automated manner or by a robot. Because the stacks are molded in the method according to the disclosure in a multi-tower, but are individually molded due to the interposition of the intermediate plates, the stacks do not yet have to be molded in the final orientation. This can significantly simplify the production process and increase accuracy. In other words, the magnet carrier modules can remain untwisted with respect to one another or can be twisted with respect to one another in the circumferential direction, for example in a downstream step, i.e., the stacks can be stacked in the circumferential direction in the same/untwisted alignment with respect to each other/in an axially aligned manner. Preferably, the stacks can be twisted by a predetermined circumferential distance in relation to one another, for example in the downstream step, and axially stacked; for example, by means of a toothing.

It is particularly advantageous if the plastic fed to a molding-on plate predominantly or only molds the magnets of the magnet carrier associated with the molding-on plate onto the respective magnet carrier. This allows separate/individual molding of the magnets per stack.

Furthermore, it is advantageous if the stack of magnet carriers equipped with magnets is molded with plastic from top to bottom in the direction of gravity. Thus, gravity is utilized for the method according to the disclosure. In other words, plastic flows through or is molded onto the stack of stacked stacks in the direction of gravity from top to bottom.

In an advantageous further development of the method, the molding-on plate can be fed the plastic from the magnet carrier adjacent on one side of the molding-on plate, and the molding-on plate can feed the plastic to the magnet carrier adjacent on the other side of the molding-on plate via a plastic dispensing device. That is, the liquid plastic, such as epoxy resin, flows from the top stack into the next stack and fills the magnet recesses/cavities and fixes/freezes the magnet in place. In other words, it is particularly convenient if the plastic is fed from (only) one axial side of the stack, and the plastic is passed from the stack adjacent on the one side to the intermediate plate, and the stack is molded by the molding nozzles of the intermediate plate.

In other words, the disclosure relates to a single stack molding method in a multi-tower with intermediate plates for producing rotor stacks. The disclosure is used in the fixation of permanent magnets in the rotor for an electric motor. If the rotor is made up of a plurality of (individual) stacks, in which the magnets in the stacks must be in the same position, the rotor cannot be produced using multi-stack molding, since all (individual) stacks or all magnets must be molded in a targeted manner. According to the disclosure, this targeted/equal molding is achieved by building up the individual stacks in the tower and introducing an intermediate plate with molding-on points/molding nozzles/molding channels between each stack. This means that the individual stacks are stacked on top of each other before a transfer process and a separate intermediate plate with molding channels is arranged between each two stacks, i.e., between each pair of stacks. This ensures that the magnets are impinged on in the same way, i.e., in the same direction, so that all magnets are pressed into the same position by the injection pressure. Thus, no additional equipment or tooling, no additional transfer presses, and no additional space are needed.

### BRIEF DESCRIPTION OF THE DRAWINGS

The disclosure is explained below with the aid of drawings. In the figures:

FIG. 1 shows a perspective view of a molding-on tool according to the disclosure with a plurality of molding-on plates for producing a rotor from a plurality of stacks,

FIG. 2 shows a molding-on plate in the form of an intermediate plate, and

FIG. 3 shows a perspective view of a section of a stack of the rotor.

### DETAILED DESCRIPTION

The figures are only schematic in nature and serve only for understanding the disclosure. The same elements are provided with the same reference symbols.

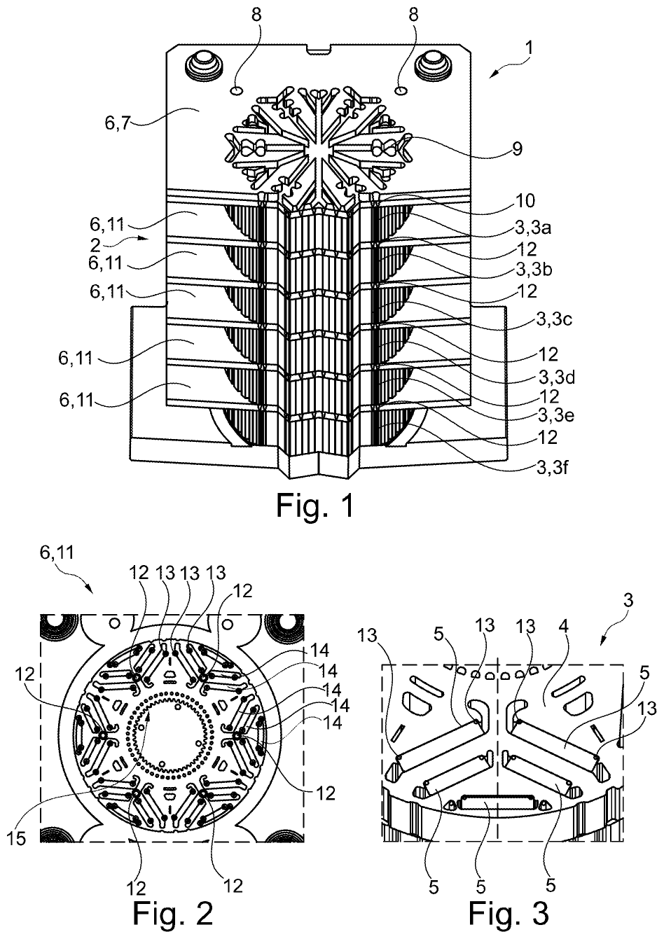

FIG. 1 shows a molding-on tool 1 according to the disclosure for producing a rotor 2 for an electric motor. The rotor 2 is made up of a plurality of stacks 3. The rotor 2 has a plurality of stacks 3 stacked one over the other in the axial direction. The stacks 3 each have a magnet carrier 4 and a plurality of magnets 5 fastened thereto (cf. FIG. 3). The magnets 5 are molded onto the magnet carrier 4 in order to fix the position. For example, the magnets 5 are molded onto the magnet carrier 4 with plastic, such as epoxy resin.

According to the disclosure, the molding-on tool 1 has at least two molding-on plates 6. The molding-on plates 6 are prepared to feed the plastic to the stacks 3 in order to mold plastic onto the magnets 5.

One molding-on plate 6 of the at least two molding-on plates 6 is formed as a sprue plate 7. The sprue plate 7 is arranged as an outermost molding-on plate 6 on an axial side of all stacks 3. The sprue plate 7 is the uppermost molding-on plate 6 in the direction of gravity. The sprue plate 7 allows the plastic to be introduced into the molding-on tool 1 and distributed from there. In the embodiment shown, the plastic can be introduced from a press (not shown), in particular a transfer press, via openings 8. The plastic introduced can be distributed in the sprue plate 7 via a plastic guiding device 9. In the embodiment shown, the plastic guiding device 9 is designed as a channel system or path network of sprue channels. In the embodiment shown, the sprue channels are connected to each other in the manner of a snowflake. This means that the sprue channels branch radially outward and in the circumferential direction of the sprue plate 7.

The plastic can flow through the plastic guiding device 9 to a plastic dispensing device 10, in the form of molding ports/molding nozzles in the embodiment shown. From the plastic dispensing device 10, the plastic is fed to the first stack 3a so that the magnets 5 of the first stack 3a, which are arranged in magnet recesses 14, are molded onto the magnet carrier 4 of the first stack 3a. The plastic dispensing device 10 is arranged to guide the plastic to suitable molding-on points 13. The molding-on points 13 are selected such that the magnets 5 are molded from behind. That is, the plastic dispensing device 10 is arranged to mold the back of the magnets 5. The position of the molding nozzles is thus matched to the position of the magnets 5 to be molded. The injection pressure pushes the magnets 5 into the desired position. In particular, the magnets 5 are molded in a targeted manner so that they abut on the outside. For example, the magnets 5 are thus molded from radially inside. Each molding nozzle can, for example, be arranged radially further inwards than a magnet 5 associated with it.

One molding-on plate 6 of the at least two molding-on plates 6 is formed as an intermediate plate 11. Preferably, the molding-on tool 1 can have a plurality of molding-on plates 6. In the embodiment shown, one intermediate plate 11 is arranged between each of two stacks 3. The intermediate plate 11 has a plastic dispensing device 12. In the embodiment shown, the plastic dispensing device 12 is formed by a plurality of molding nozzles, for example in the form of through holes, which are arranged distributed over the circumference of the intermediate plate 11. In particular, the molding nozzles can be arranged in an evenly distributed manner. The plastic dispensing device 12 is arranged to guide the plastic to the suitable molding-on points 13. That is, the plastic dispensing device 12 is arranged to mold the back of the magnets 5. The injection pressure pushes the magnets 5 into the desired position. In particular, the magnets 5 are molded in a targeted manner so that they abut on the outside. For example, the magnets 5 are thus molded from radially inside. Each molding nozzle can, for example, be arranged radially further inwards than a magnet 5 associated with it. The position of the molding nozzles is thus matched to the position of the magnets 5 to be molded. The intermediate plate 11 is thus designed in such a way that a melt flow analogous to the sprue plate 7 flows behind the magnets 5. From the plastic dispensing device 12, the plastic is fed to the stack 3b, 3c, 3d, 3e, 3f associated with the intermediate plate 11 so that the magnets 5 of the associated stack 3b, 3c, 3d, 3e, 3f, which are arranged in the magnet recesses 14, are molded onto the magnet carrier 4 of the associated stack 3b, 3c, 3d, 3e, 3f.

In FIG. 2, a contour of the stacks 3 is indicated. Each stack 3 has an inner toothing 15 on its radial inner side. The inner toothing 15 is arranged centrally. The inner toothing 15 allows the individual, axially stacked stacks 3 to be connected to each other in a non-rotatable manner via a shaft (not shown).

The disclosure also relates to a method for producing the rotor 2, which is explained with reference to FIG. 1. According to the disclosure, the magnet carrier 4 of one stack 3, preferably of all stacks 3, is equipped with the magnets 5 and the plurality of stacks 3, i.e., the magnet carriers 4 equipped with the magnets, are stacked one over the other in the axial direction. In another step, the molding-on plate 6, which is formed as an intermediate plate 11, is arranged between two of the magnet carriers 4. Preferably, a molding-on plate 6 in the form of an intermediate plate 11 is arranged between each pair of magnet carriers or stacks. In a further step, plastic is fed to the molding-on plate 6, preferably to the molding-on plates 6, in order to, at the magnet carrier 4 assigned to the molding-on plate 6, preferably at all magnet carriers 4 assigned in each case to a molding-on plate 6, mold the magnets 5 associated with the magnet carrier 4 onto the magnet carrier 4. Thus, the plastic fed to a molding-on plate 6 predominantly or only molds the magnets 5 of the magnet carrier 4 associated with the molding-on plate 6 onto the respective magnet carrier 4.

In the embodiment shown, the plurality of magnet carriers 4 equipped with magnets 5 are stacked one over the other in the same orientation in the circumferential direction. Alternatively, the plurality of magnet carriers 4 equipped with magnets 5 can be arranged offset in the circumferential direction by a predetermined circumferential distance, although this is not shown.

In the method according to the disclosure, the stack of magnet carriers 4 equipped with magnets 5 is molded with plastic from top to bottom in the direction of gravity. This means that the plastic melt flows through the stack in the direction of gravity. Thus, the magnets 5 are molded first in the first stack 3a, then in the second stack 3b, then in the third stack 3c, and so forth.

The plastic is introduced via the molding-on plate 6 (formed as a sprue plate 7) and the magnets 5 in the first stack 3a are molded. According to the disclosure, the plastic is then fed to each molding-on plate 6 (formed as an intermediate plate 7) from the magnet carrier 4 adjacent on one side of the respective molding-on plate 6, i.e., from the magnet carrier 4 adjacent at the top in the direction of gravity, and each molding-on plate 6 (formed as an intermediate plate 7) feeds the plastic to the magnet carrier 4 adjacent on the other side of the respective molding-on plate 6, i.e., to the magnet carrier 4 adjacent at the bottom in the direction of gravity, for example via the plastic dispensing device 12. As a result, each magnet 5 is molded in a targeted manner.

### LIST OF REFERENCE SYMBOLS

1 Molding-on tool

2 Rotor

3 Stack

4 Magnet carrier

5 Magnet

6 Molding-on plate

7 Sprue plate

8 Opening

9 Plastic guiding device

10 Plastic dispensing device

11 Intermediate plate

12 Plastic dispensing device

13 Molding-on point

14 Magnet recess

15 Inner toothing

1. A molding-on tool for producing a rotor, the rotor having a plurality of stacks, which are stacked one over the other in an axial direction and each have a magnet carrier and a plurality of magnets fastened thereto, the molding-on tool comprising: at least two molding-on plates, configured for feeding plastic in order to mold plastic onto the magnets to fix a position on the magnet carrier.

2. The molding-on tool according to claim 1, wherein one of the at least two molding-on plates is formed as a sprue plate arranged as an outermost molding-on plate on an axial side of all the stacks, and the other of the at least two molding-on plates is formed as an intermediate plate arranged as an inner molding-on plate inside an entirety of the stacks.

3. The molding-on tool according to claim 1, wherein the molding-on tool has its own molding-on plate for each stack.

4. The molding-on tool according to claim 1, wherein the molding-on plates each have a plastic guiding device for guiding the plastic and/or a plastic dispensing device for feeding the plastic to the stack associated with the molding-on plate.

5. The molding-on tool according to claim 4, wherein the plastic dispensing device is matched to the position of the magnets of the stacks to be molded in such a way that the magnets can be molded from behind.

6. A method for producing a rotor, the method comprising: in one step equipping a magnet carrier with magnets and stacking a plurality of magnet carriers equipped with magnets one over the other in an axial direction, in another step arranging at least one molding-on plate between two magnet carriers of the plurality of magnet carriers, and in a further step feeding plastic to the molding-on plate in order to mold the magnets associated with the magnet carrier onto the magnet carrier at a magnet carrier associated with the molding-on plate.

7. The method according to claim 6, further comprising: stacking the plurality of magnet carriers equipped with magnets one over the other in a same orientation in a circumferential direction.

8. The method according to claim 6, wherein the plastic fed to the molding-on plate predominantly or only molds the magnets of the magnet carrier associated with the molding-on plate onto the respective magnet carrier.

9. The method according to claim 6, further comprising: molding the stack of magnet carriers equipped with magnets with plastic from top to bottom in a direction of gravity.

10. The method according to claim 6, wherein the molding-on plate is fed the plastic from the magnet carrier adjacent on one side of the molding-on plate and/or the molding-on plate feeds the plastic to the magnet carrier adjacent on the other side of the molding-on plate via a plastic dispensing device.

11. A molding-on tool for producing a rotor, comprising:
at least two molding-on plates configured for feeding plastic to mold plastic onto magnets to fix a position on a magnet carrier of the rotor, wherein the rotor has a plurality of stacks of magnet carriers, which are stacked one over the other in an axial direction, wherein one of the at least two molding-on plates is arranged as an outermost molding-on plate on an axial side of all the stacks, and the other of the at least two molding-on plates is arranged as an inner molding-on plate inside an entirety of the stacks.

12. The molding-on tool according to claim 11, wherein each of the at least two molding-on plates has a plastic guiding device for guiding the plastic and a plastic dispensing device for feeding the plastic to the stack associated with the molding-on plate.
